(19) United States
(12) Patent Application Publication
(10) Pub. No.: US 2026/0113723 A1
(43) Pub. Date: Apr. 23, 2026

(54) TIME-DIVISION-DUPLEX REPEATERS WITH GLOBAL NAVIGATION SATELLITE SYSTEM TIMING RECOVERY

(71) Applicant: Pivotal Commware, Inc., Bothell, WA (US)

(72) Inventors: Alexander Remley Katko, Seattle, WA (US); Melroy Machado, Seattle, WA (US); Marius Marcel Pop, Gig Harbor, WA (US); Jacob Tyler Repp-Bartel, Snohomish, WA (US); Daniel Lee Schaeffer, Seattle, WA (US)

(21) Appl. No.: 19/412,709

(22) Filed: Dec. 8, 2025

Related U.S. Application Data
(63) Continuation of application No. 18/607,965, filed on Mar. 18, 2024, now Pat. No. 12,495,377.
Application No. 18/607,965 is a continuation of application No. 18/136,238, filed on Apr. 18, 2023, now Pat. No. 11,937,199.
(60) Provisional application No. 63/332,118, filed on Apr. 18, 2022.

(51) Int. Cl. H04W 56/00; H04B 7/155

(52) U.S. Cl. CPC H04W 56/0045; H04B 7/155; H04W 56/0015

(57) ABSTRACT

A repeater for wireless communications systems can include a time-division-duplex (TDD) architecture with a timing recovery system for switching between uplink and downlink. In some approaches, the timing recovery system can receive a timing reference from a global navigation satellite system (GNSS) such as Global Positioning System (GPS), Global Navigation Satellite System (GLONASS), or Galileo.

### CROSS-REFERENCE TO RELATED APPLICATIONS

This Utility Patent Application is a Continuation of U.S. patent application Ser. No. 18/607,965 filed on Mar. 18, 2024, now U.S. Pat. No. 12,495,377 issued on Dec. 9, 2025, which is a Continuation of U.S. patent application Ser. No. 18/136,238 filed on Apr. 18, 2023, now U.S. Pat. No. 11,937,199 issued on Mar. 19, 2024, which is based on previously filed U.S. Provisional Patent Application No. 63/332,118 filed on Apr. 18, 2022, the benefit of the filing date of which is hereby claimed under 35 U.S.C. § 119(e) and § 120, and the contents of which are each further incorporated in entirety by reference.

### TECHNICAL FIELD

The application has to do with repeaters for wireless communications.

### BACKGROUND

Wireless communications, including 5th generation (5G) wireless communications, can be enhanced by placement of repeaters that extend or otherwise amplify the signals from wireless base stations. Repeaters can have several radio frequency (RF) architectures that are viable. One architecture is operation of the repeater in a full duplex mode. In this architecture, there can be four separate antennas for each of the Donor and Service side of the repeater device. These are generally Horizontal-polarization Uplink (H-UL), Vertical-polarization Uplink (V-UL), Horizontal-polarization Downlink (H-DL), and Vertical-polarization Downlink (V-DL). This is a robust architecture in that it is generally immune to changes in the underlying air interface such as Downlink-Uplink (DL-UL) allocation, dynamic slot formats, and flex slots/symbols—all of which are part of the 5G standard from 3^{rd} Generation Partnership Project (3GPP).

However, it adds cost compared to other architectures: It can include four Donor unit apertures, generally, as well as a potentially costly set of Monolithic Microwave Integrated Circuit (MMIC) chains for the conducted RF subsystems. In addition, the RF gain can be limited due to stringent isolation requirements.

Another architecture may use an off-the-shelf or modified user equipment (UE) modem. In this architecture, the modem can recover network synchronization to have knowledge of when the macro-level system is Downlink (DL), Uplink (UL), or even Flex. The modem can then use that information to control the MMIC chains for the conducted RF subsystems. The conducted RF architecture is then inherently time-division-duplex (TDD), rather than full duplex: it only transmits (and receives) in either DL or UL directions at any instant, rather than both. This improves performance by relaxing isolation requirements. It also reduces the cost allocated to the antennas and (potentially) the MMIC chains.

However, the cost of the modem can be prohibitively high. The modem itself, as a silicon chip, can be costly. The modem might entail a substantial startup/license cost to the modem supplier, and can be complex to implement and bring up on a Printed Circuit Board (PCB).

A technical problem, therefore, is to realize a repeater that uses a time division duplex (TDD) RF architecture but does not entail the high cost and complexity that come with using a UE modem. This can be accomplished if there is a dedicated timing recovery subsystem. The conventional way to accomplish a timing recovery subsystem is to use custom software running on high-performance silicon, to implement a partial UE modem. This requires frequency conversion from RF to Inphase component and Quadrature component (I/Q) baseband or Intermediate Frequency (IF), at least one high-speed analog to digital converter (ADC), and silicon running appropriate software. There is additional cost and complexity in implementing this solution.

### BRIEF DESCRIPTION OF THE DRAWINGS

FIG. 1 depicts an example of a full-duplex (FD) repeater system.

FIGS. 2A-2C depict various examples of time-division-duplex (TDD) repeater systems.

FIG. 3 depicts an example of a TDD repeater system with timing recovery using a Global Navigation Satellite System (GNSS).

FIGS. 4-5 depict examples of switch timing for uplink and downlink in a TDD repeater system.

### DESCRIPTION OF VARIOUS EMBODIMENTS OF THE INVENTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Similarly, the phrase “in another embodiment” as used herein does not necessarily refer to a different embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

The invention is a timing recovery subsystem that utilizes out-of-band communication to synchronize to the desired communications network (e.g., a 5G network). The out-of-band communication can include three pieces of data:
1. A reference to “absolute time”, or the synchronized time of the communications network. This can be provided by global navigation satellite system (GNSS) such as Global Positioning System (GPS), Global Navigation Satellite System (GLONASS), or Galileo. In other approaches, the reference to absolute time can be provided by a non-GNSS synchronization protocol such as Institute of Electrical and Electronics Engineers (IEEE) 1588, Synchronous Ethernet (SyncE), or Time Sensitive Networking (TSN).
2. The (locally or globally used) DL and UL pattern of the 5G network within a radio frame. This is also variously known as the TDD pattern, TDD allocation, slot format, and others
3. The start of a radio frame, referenced to “absolute time,” of the serving base station/Next Generation NodeB (gNB).

With this information, the timing recovery subsystem can be implemented using a low cost microcontroller. It does not require an Field Programmable Gate Array (FPGA); Digital Signal Processor (DSP); high-speed ADC; or frequency converter from RF to baseband or IF. The microcontroller may make use of the information above to switch the MMIC chain/RF architecture between DL and UL on a scheduled basis: it knows the absolute time at any instant, it knows the pattern for each radio frame, and it knows when the radio frame starts.

This invention includes delivery of the above information with in-band or out-of-band communication. The information may be gathered in any fashion, from a local Next Generation NodeB (gNB) or higher protocol layer (or the core network). The information is then provided to the timing recovery subsystem of the repeater. Additional information could also be provided to assist with the timing recovery subsystem.

This could be done over a wide variety of interfaces. One possible implementation is to provide the information from a cloud-based management system. Another possible implementation is to provide the information from a device management server over a device management protocol such as Lightweight Machine to Machine (LWM2M), Open Mobile Alliance Device Management (OMA-DM), or Message Queues Telemetry Transport (MQTT). The physical interface could be conducted (as in Ethernet over copper or fiber) or wireless (as in any flavor of Global System for Mobile Communications (GSM), Long Term Evolution (LTE), Bluetooth™, WiFi™, etc). In any case, the interface could also be used to provide other diagnostic information, either to assist the timing recovery subsystem (such as RF power levels) or for general performance diagnostics.

While the following disclosure describes repeater systems with timing recovery, it will be appreciated that the timing recovery aspects that are herein disclosed can also be used in non-repeater contexts. For example, a signal receiver can use the timing recovery described herein to determine when to receive. As another example, a signal transmitter can use the timing recovery described herein to determine when to transmit to either minimize or maximize interference.

### Illustrative Repeater Systems

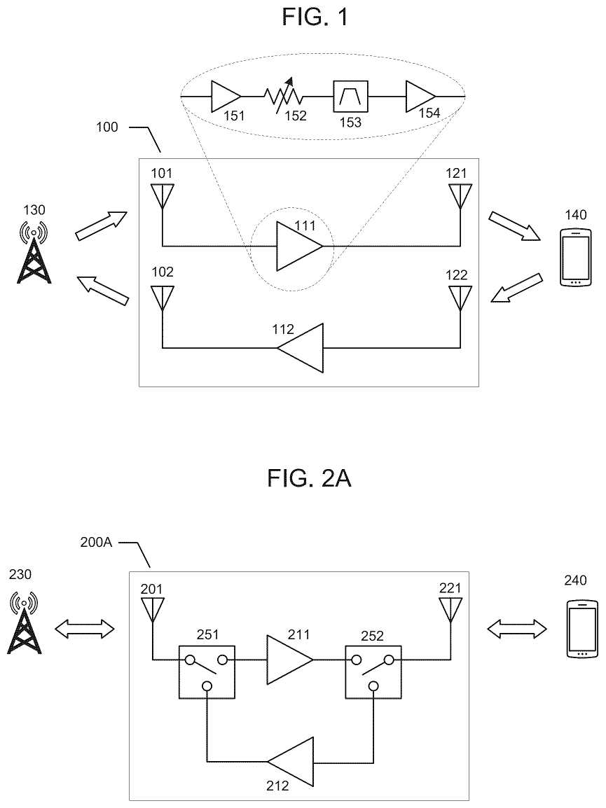

With reference now to FIG. 1, an illustrative example of a full duplex wireless repeater 100 is depicted. The repeater includes a donor downlink (DD) antenna 101 that receives downlink RF signals from a wireless base station 130; amplifies the received downlink RF signals with a downlink RF amplifier 111; and retransmits the amplified downlink RF signals to user equipment 140 with a service downlink (SD) antenna 121. The repeater further includes a service uplink (SU) antenna 122 that received uplink RF signals from the user equipment 140; amplifies the received uplink RF signals with an uplink RF amplifier 112; and retransmits the amplified uplink RF signals to the wireless base station 130.

As shown by the zoom in FIG. 1, each of the amplifiers 111 and 112 may consist of an RF amplification chain that can include one or more low noise amplifiers 151, adjustable attenuators 152, band pass filters 153, and power amplifiers 154. The overall amplifier can then be adjusted by, for example, adjusting an attenuator, adjusting a gain of the low noise amplifier and/or power amplifier, turning a low noise amplifier and/or power amplifier on or off, or any combination of these adjustments.

In some approaches, the repeater may repeat RF communications having two orthogonal polarization, e.g., vertical and horizontal. In these approaches, all of the elements of the repeater 100 may be duplicated, with a first set of the elements serving to repeat vertically-polarized RF communications and a second set of the elements serving to repeat horizontally-polarized RF communications. Thus, these dual-polarization repeaters can have as many as eight antennas: four donor antennas communicating with the base station 130 and four service antennas communicating with the user equipment 140.

It can therefore be seen that operating a repeater in full duplex mode can have negative implications in terms of cost, size, and weight of the repeater because of the number of components that are needed to operate in full duplex and dual polarization; and also power consumption because four power amplifiers are consuming energy at the same time; and also mechanical complexity because of the need to provide RF isolation to prevent feedback oscillation. A time-division-duplex repeater avoids these negative implications, but with the added complexity that the TDD repeater needs a timing recovery system to be aware of when to operate in uplink mode and when to operate in downlink mode.

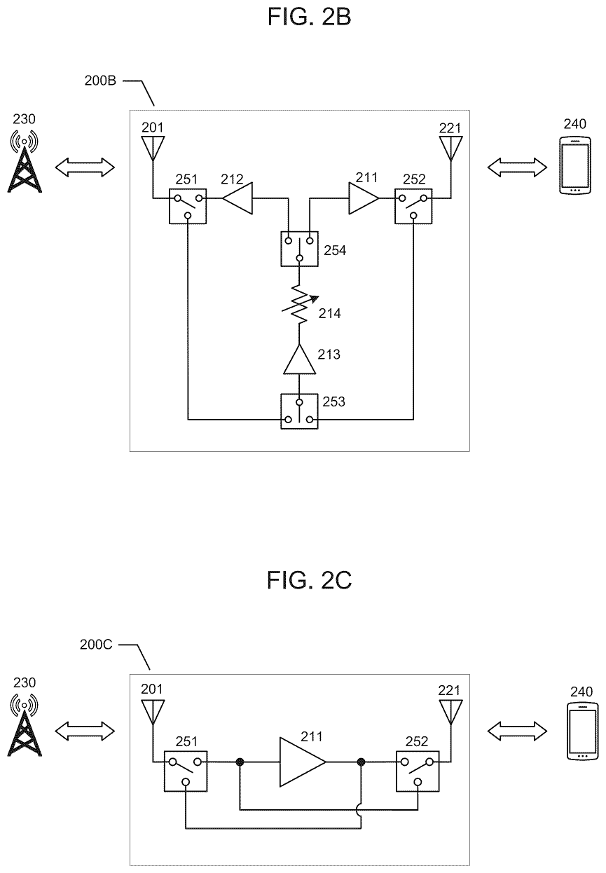

With reference now to FIGS. 2A-2C, illustrative embodiments of TDD wireless repeaters are depicted. In FIG. 2A, repeater 200A includes a donor antenna 201 that transmits RF communications to, or receives RF communications from, a wireless base station 230, depending on whether the repeater is operating in uplink mode or downlink mode, respectively. Repeater 200A further includes a service antenna 221 that transmits RF communications to, or receives RF communications from, user equipment 240, depending on whether the repeater is operating in downlink mode or uplink mode, respectively. Repeater 200A includes a downlink amplifier 211, an uplink amplifier 212, and RF switches 251 and 252 that are operable to switch the repeater between downlink mode and uplink mode.

As with FIG. 1, each amplifier 211, 212 can actually consist of an RF amplification chain consisting of one or more low noise amplifiers, attenuators, band pass filters, and power amplifiers. In some approaches, as illustrated in FIG. 2B, some of these amplifier components can be shared by both uplink and downlink RF amplification chains; in this example, there is a dedicated downlink power amplifier 211 and a dedicated uplink power amplifier 212, but the uplink and downlink amplification chains share a common low noise amplifier 213 and attenuator 214, with RF switches 251, 252, 253, and 254 that are operable to switch the repeater 200B between downlink mode and uplink mode. In other approaches, as illustrated in FIG. 2C, all of the amplifier components can be shared by both uplink and downlink; in this example, there is a single amplifier (or amplifier chain) 211, with RF switches 251 and 252 that are operable to switch the repeater 200C between downlink mode and uplink mode.

The TDD repeaters 200A, 200B, and 200C may repeat RF communications having two orthogonal polarization, e.g., vertical and horizontal. In these approaches, all of the elements of the repeaters 200A, 200B, and 200C may be duplicated, with a first set of the elements serving to repeat vertically-polarized RF communications and a second set of the elements serving to repeat horizontally-polarized RF communications.

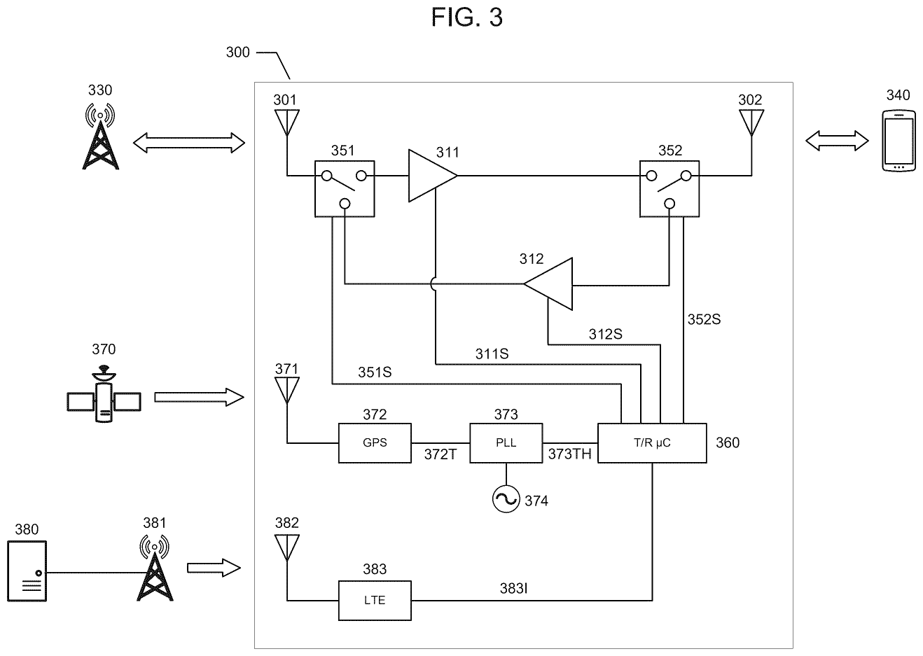

With reference now to FIG. 3, an illustrative scenario for timing recovery for a wireless TDD repeater is depicted. In this example, wireless repeater 300 includes a donor antenna 301 for communication with wireless base station 330; a service antenna 302 for communication with user equipment 340; a downlink amplifier 311 that can be switched on or off with control signal 311S; an uplink amplifier 312 that can be switch on or off with control signal 312S; and RF switches 351, 352 that can be toggled with control signals 351S and 351S, respectively.

The repeater includes a timing control unit, such as microcontroller unit 360, which outputs the control signals 311S, 312S, 3351S, and 352S that switch the repeater between uplink mode and downlink mode. The timing control unit can determine a schedule for switching between uplink and downlink based on several inputs.

First, the timing control unit can receive a reference to absolute time for communication on the wireless network. For example, the repeater can include an antenna 371 and receiver 372 operable to receive information from a global navigation satellite system (GNSS) 370 such as Global Positioning System (GPS), Global Navigation Satellite System (GLONASS), or Galileo. The GNSS receiver can output an absolute time reference signal 372T, for example a one-pulse-per-second (1PPS) signal. Signals from a GNSS system can have intermittent outages, e.g., due to satellite flyover/handoff, weather conditions, transient physical obstructions, etc. To accommodate for brief periods of outage, the repeater can include a phase-locked loop (PLL) unit 373 that provides a “holdover” mode with reference to a high quality local oscillator 374, e.g., a crystal oscillator such as a temperature compensated crystal oscillator (TCXO), oven controlled crystal oscillator (OXCO), voltage controlled crystal oscillator (VCXO), or digital controlled crystal oscillator (DCXO). Then, the PLL unit can output an absolute time reference signal 373TH with holdover to the timing control unit 360 to provide reliable timing during the brief periods of GNSS outage. In some approaches, the quality of the timing reference in holdover mode can be improved by applying a correction factor within the microcontroller unit 360, to compensate for any drift in the holdover timing and therefore reduce any phase error between absolute time and the start of a radio frame. For example, user equipment 340 in communication with the repeater can provide key performance indicators (KPIs) as feedback to tune or validate a correction factor that is applied when the PLL is in holdover mode. While the illustrative example of FIG. 3 depicts a repeater that uses signals from a global navigation satellite system (GNSS) to provide a reference to absolute time, in other approaches, the reference to absolute time can be provided by a non-GNSS synchronization protocol such as IEEE 1588, SyncE, or TSN.

Second, the timing control unit can determine a reference to the start time of a radio frame relative to absolute time. In some approaches, the start time is defined, e.g., by a wireless service provider and/or according to a wireless service standard, by adding a selected integer multiple of radio frame lengths to a start time of a coordinated universal time (UTC) second. The reference to the start time of the radio frame can be received in various ways. In the illustrative example of FIG. 3, the repeater includes an LTE antenna 382 and LTE receiver 383, and the information is communicated by a server 380 by way of a wireless base station 381 that communicates with the LTE component, which then relays information 383I to the timing control unit 360. The server 380 could be, for example, a cloud-based management system or a device management server, which might communicate with the repeater via a device management protocol such as LWM2M, OMA-DM, or MQTT. While the illustrative example of FIG. 3 depicts an LTE antenna, the reference to the start time of the radio frame can be received in other ways, for example, via Ethernet, GSM, Bluetooth, WiFi, or similar protocols; or by key-in during installation of the wireless repeater; or by in-band communication using the wireless base station channel 330 instead of a separate out-of-band wireless base station channel 381. In some approaches, the start time of the radio frame can be offset by an over-the-air time-of-flight between the repeater 300 and the wireless base station 330, and information about this time-of-flight value can be received by similar ways as discussed above.

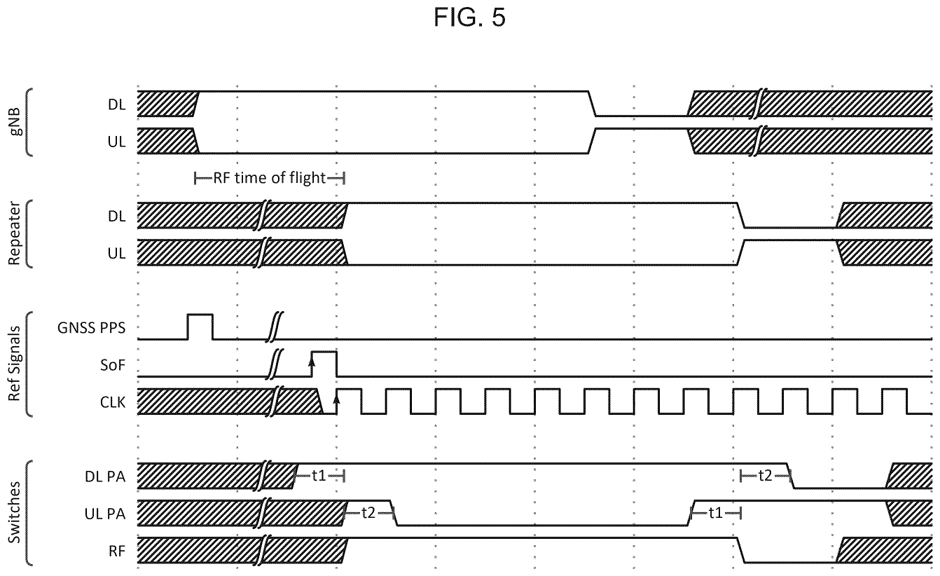

Third, the timing control unit can determine a slot pattern for communication on the wireless network. In some approaches, the slot pattern is defined, e.g., by a wireless service provider and/or according to a wireless service standard. For example, the slot pattern might include four downlink slots followed by one uplink slot, as in the illustrative timing example of FIG. 5, as discussed below. The slot pattern can be received in various ways. In the illustrative example of FIG. 3, the repeater includes an LTE antenna 382 and LTE receiver 383, and the information is communicated by a server 380 by way of a wireless base station 381 that communicates with the LTE component, which then relays information 383I to the timing control unit 360. The server 380 could be, for example, a cloud-based management system or a device management server, which might communicate with the repeater via a device management protocol such as LWM2M, OMA-DM, or MQTT. While the illustrative example of FIG. 3 depicts an LTE antenna, the slot pattern can be received in other ways, for example, via Ethernet, GSM, Bluetooth, WiFi, or similar protocols; or by key-in during installation of the wireless repeater; or by in-band communication using the wireless base station channel 330 instead of a separate out-of-band wireless base station channel 381.

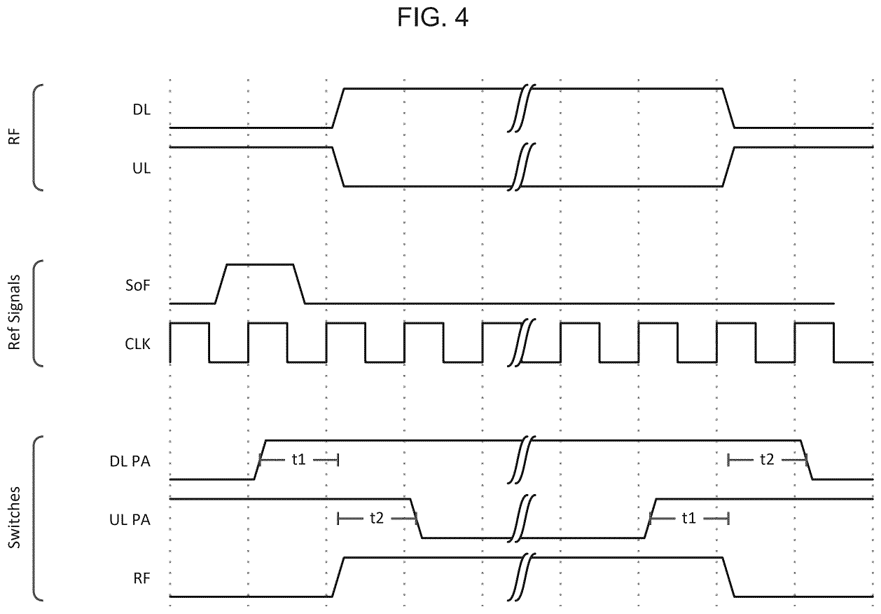

With reference now to FIG. 4, an illustrative timing diagram for switching between uplink and downlink for a TDD repeater is depicted. The DL and UL plots show that in this example, the repeater should start in uplink mode, switch to downlink mode, and then switch back to uplink mode. The start-of-frame (SoF) plot indicates the start of the radio frame for downlink as determined by the timing recovery system. The clock (CLK) plot indicates a clock output that can be used to time the switching of the various control lines 351S, 352S, 311S, and 312S in FIG. 3. For example, the CLK output can be included in the 373TH signal that is output from the PLL 373 with holdover. Thus, for example, the DL PA plot illustrates an example of a schedule for switching of the downlink amplifier 311, i.e., the control signal 311S; the UL PA plot illustrates an example of a schedule for switching of the uplink amplifier 312, i.e., the control signal 312S; and the RF signal illustrates an example of a schedule for switching of the RF switches 351, 352, i.e., the control signals 351S, 352S. As illustrated in FIG. 4, in some approaches, the schedules for switching of the uplink and downlink amplifiers can be offset from the schedule for switching of the RF switches. For example, the DL PA can switch on with a time offset t1 before the first toggle of the RF switch, and switch off with a time offset t2 after the second toggle of the RF switch; and the UL PA can switch off with a time offset t2 after the first toggle of the RF switch, and switch on with a time offset t1 before the second toggle of the RF switch. These time offsets t1 and t2 can be used to provide that the amplifiers 311 and 312 are fully turned on or fully turned off before the RF switches are switched to deliver RF energy to the relevant amplifier, therefore reducing any transients due to amplifier turn on or turn off time. In other words, offset time t1 can be a time larger than a turn-on transient time for amplifiers 311 and 312, and offset time t2 can be a time larger than a turn-off transient time for an amplifiers 311 and 312.

With reference now to FIG. 5, another illustrative example for switching between uplink and downlink for a TDD repeater is depicted. In this example, the slot pattern includes four downlink slots and one uplink slot, as indicated by the schedule for DL and UL at the wireless base station (in this example, the wireless base station is a 5G gNB). As shown in the figure, the start of frame at the repeater can be delayed to account for time of flight of communications signals between the wireless base station and the repeater. The GNSS PPS plot indicates a one pulse per second output of the PLL 373; the CLK plot indicates a clock output of the PLL 373, as in FIG. 4; and the SoF plot indicates a start of radio frame as determined by the timing control unit 360. In this illustrative example, as in FIG. 4, the amplifier switches DL PA and UL PA are advanced or retarded by times t1 and t2 to accommodate turn-on and turn-off transient times for the amplifiers.

In one or more embodiments, a computing device may include one or more embedded logic hardware devices instead of one or more central processing units (CPUs), such as Application Specific Integrated Circuits (ASICs), Field Programmable Gate Arrays (FPGAs), Programmable Array Logics (PALs), or the like, or combination thereof. The embedded logic hardware devices may directly execute embedded logic to perform actions. Also, in one or more embodiments (not shown in the figures), the computer device may include one or more hardware microcontrollers instead of a central processing unit (CPU). In one or more embodiments, the one or more microcontrollers may directly execute their own embedded logic to perform actions and access their own internal memory and their own external Input and Output Interfaces (e.g., hardware pins and/or wireless transceivers) to perform actions, such as System On a Chip (SOC), or the like. Additionally, in one or more embodiments, the computational resources may be distributed over a cloud computing platform and the like. One or more embodiments include transitory and/or non-transitory computer readable media that can be installed on a computing device.

Embodiments of the invention are set forth in the following numbered clauses:
1. A method of operating a wireless repeater, comprising:
   receiving a reference to absolute time for communication on a wireless network;
   determining a reference to start time of a radio frame relative to the absolute time;
   determining a slot pattern for communication on the wireless network; and
   determining a schedule for switching the wireless repeater between uplink and downlink based on the received absolute time reference, the determined radio frame start time, and the determined slot pattern.
2. The method of clause 1, wherein the determining of the start time of the radio frame includes adding a selected integer multiple of radio frame lengths to a start time of a coordinated universal time (UTC) second.
3. The method of clause 1, wherein the determining of the start time of the radio frame includes offsetting the start time by a time of flight between the repeater and a base station.
4. The method of clause 2, wherein the radio frame lengths are each 10 milliseconds (ms).
5. The method of clause 1, further comprising:
   switching the wireless repeater between uplink and downlink according to the determined schedule.
6. The method of clause 5, wherein the wireless repeater includes one or more RF switches, amplifiers, and/or attenuators, and the switching includes adjusting the one or more RF switches, amplifiers, and/or attenuators.
7. The method of clause 1, wherein the receiving of the reference to absolute time is a receiving from a global navigation satellite system (GNSS) such as Global Positioning System (GPS), Global Navigation Satellite System (GLONASS), or Galileo.
8. The method of clause 7, wherein the receiving from the GNSS is an intermittent receiving with one or more outage intervals, and the determining of the schedule for switching the wireless repeater includes:
   during the one or more outage intervals, approximating the reference to absolute time with a local oscillator.
9. The method of clause 8, wherein the local oscillator is a crystal oscillator that comprises a temperature compensated crystal oscillator (TCXO), oven controlled crystal oscillator (OXCO), voltage controlled crystal oscillator (VCXO), or digital controlled crystal oscillator (DCXO).
10. The method of clause 8, wherein the approximating is an approximating with a phase-locked loop (PLL) in holdover mode coupled to the local oscillator.
11. The method of clause 1, wherein the receiving of the reference to absolute time is a receiving via a non-GNSS synchronization protocol that comprises Institute of Electrical and Electronics Engineers (IEEE) 1588, Synchronous Ethernet (SyncE), or Time Sensitive Networking (TSN).
12. The method of clause 1, wherein:
   the wireless repeater is a repeater for communication within a selected communication frequency band; and
   the determining of the slot pattern and/or radio frame start time is a receiving of the slot pattern and/or radio frame start time within the selected wireless frequency band.
13. The method of clause 1, wherein:
   the wireless repeater is a repeater for communication within a selected communication frequency band; and
   the determining of the slot pattern and/or radio frame start time is a receiving of the slot pattern and/or radio frame start time outside of the selected wireless frequency band.
14. The method of clause 13, wherein the selected communication frequency band is an FR1 or FR2 band for 5G wireless communications.
15. The method of clause 13, wherein the selected communication frequency band is a millimeter wave (mmW) frequency band.
16. The method of clause 13, wherein the receiving outside of the selected wireless frequency band includes a receiving via one or more out-of-band modes or protocols that comprises Ethernet, Global System for Mobile Communications (GSM), Long Term Evolution (LTE), Bluetooth™, or WiFi™.
17. The method of clause 13, wherein the receiving outside of the selected wireless frequency band includes a receiving via key-in during installation of the wireless repeater.
18. The method of clause 13, wherein the receiving outside of the selected wireless frequency band includes a receiving via a device management protocol that comprises Lightweight Machine to Machine (LWM2M), Open Mobile Alliance Device Management (OMA-DM), or Message Queues Telemetry Transport (MQTT).
19. The method of clause 18, wherein the receiving via the device management protocol includes a receiving from a cloud-based management system or device management server.
20. The method of clause 1, wherein the determining of the schedule for switching the wireless repeater includes:
   determining a nominal start time for an uplink or downlink time interval within the radio frame; and
   offsetting an actual start time for the uplink or downlink time interval to be earlier or later than the nominal start time by a selected offset amount.
21. The method of clause 1, wherein the determining of the schedule for switching the wireless repeater includes:
   determining a nominal end time for an uplink or downlink time interval within the radio frame; and
   offsetting an actual end time for the uplink or downlink time interval to be earlier or later than the nominal end time by a selected offset amount.
22. The method of clause 20 or 21, wherein the selected offset amount includes an offset for transient time for switching the wireless repeater between uplink or downlink according to the determined schedule.
23. A wireless repeater, comprising:
   a first antenna for communication with a wireless base station;
   a second antenna for communication with user equipment;
   one or more switches, amplifiers, and/or attenuators coupled to the first and second antennas for alternation between uplink and downlink modes; and
   a timing recovery system coupled to the one or more switches, amplifiers, and/or attenuators and configured to carry out the method of any of clauses 1-22.
24. A computer-readable medium storing instructions to cause a wireless repeater to carry out the method of any of clauses 1-22.
25. A system, comprising: a cloud-based management system or device management server configured to transmit the received slot pattern and/or radio frame of clause 19.

What is claimed as new and desired to be protected by Letters Patent of the united States is:

1. A method of operating a wireless repeater on a network, comprising:
obtaining a schedule over a communication frequency band;
collecting one or more of a slot pattern or a radio frame start time that is communicated outside of the selected communication frequency band;
employing a vertical polarization and a horizontal polarization for communication with the wireless router; and
wherein the schedule and a time reference are used to collect the one or more of the radio frame start time or the slot pattern and cause switching by the wireless repeater between uplink communication and downlink communication on the network.

2. The method of claim 1, further comprising:
employing a correction factor to compensate for one or more of drift in holdover timing or reduce phase error between the time reference and the radio frame start time.

3. The method of claim 2, wherein employing the correction factor, further comprises:
collecting one or more key performance indicators based on feedback from user equipment that are used to validate the correction factor and tune the compensation provided by the correction factor.

4. The method of claim 1, further comprising:
employing a pair of antennas for the wireless repeater to concurrently provide the vertically polarized communication and the horizontally polarized communication.

5. The method of claim 1, further comprising:
arranging one or more amplifier components to be shared by the wireless router in amplification of the uplink communication and the downlink communication.

6. The method of claim 1, further comprising:
collecting one or more of the slot pattern or the radio frame start time based on communication over a terrestrial communication frequency band that is outside of the communication frequency band, wherein the other communication frequency band supports one or more of Ethernet, Global System for Mobile Communications (GSM), Long Term Evolution (LTE), Bluetooth™, or WiFi™.

7. The method of claim 1, wherein the obtainment of the schedule further comprises:
obtaining an offset to compensate for a transient time interval in the switching between uplink communication and downlink communication on the network.

8. The method of claim 1, further comprising:
collecting one or more absolute time values from another communication frequency band that is outside of the communication frequency band, wherein the time reference is based on the absolute time value; and
approximating the time reference during one or more outage intervals in the local collection of the one or more absolute time values.

9. The method of claim 8, wherein the other communication frequency band comprises one or more of a terrestrial communication frequency band or a satellite communication frequency band this outside of the communication frequency band.

10. The method of claim 1, further comprising:
employing a local timing control component to obtain one or more of the time reference, the radio frame start time, or the slot pattern.

11. An apparatus for repeating communication with a wireless repeater on a network, wherein the apparatus executes instructions that cause actions, comprising:
obtaining a schedule over a communication frequency band;
collecting one or more of a slot pattern or a radio frame start time that is communicated outside of the selected communication frequency band;
employing a vertical polarization and a horizontal polarization for communication with the wireless router; and
wherein the schedule and a time reference are used to collect the one or more of the radio frame start time or the slot pattern and cause switching by the wireless repeater between uplink communication and downlink communication on the network.

12. The apparatus of claim 11, further comprising:
employing a correction factor to compensate for one or more of drift in holdover timing or reduce phase error between the time reference and the radio frame start time.

13. The apparatus of claim 12, wherein employing the correction factor, further comprises:
collecting one or more key performance indicators based on feedback from user equipment that are used to validate the correction factor and tune the compensation provided by the correction factor.

14. The apparatus of claim 11, further comprising:
employing a pair of antennas for the wireless repeater to concurrently provide the vertically polarized communication and the horizontally polarized communication.

15. The apparatus of claim 11, further comprising:
arranging one or more amplifier components to be shared by the wireless router in amplification of the uplink communication and the downlink communication.

16. The apparatus of claim 11, further comprising:
collecting one or more of the slot pattern or the radio frame start time based on communication over a terrestrial communication frequency band that is outside of the communication frequency band, wherein the other communication frequency band supports one or more of Ethernet, Global System for Mobile Communications (GSM), Long Term Evolution (LTE), Bluetooth™, or WiFi™.

17. The apparatus of claim 11, wherein the obtainment of the schedule further comprises:
obtaining an offset to compensate for a transient time interval in the switching between uplink communication and downlink communication on the network.

18. The apparatus of claim 11, further comprising:
collecting one or more absolute time values from another communication frequency band that is outside of the communication frequency band, wherein the time reference is based on the absolute time value; and
approximating the time reference during one or more outage intervals in the local collection of the one or more absolute time values.

19. The apparatus of claim 18, wherein the other communication frequency band comprises one or more of a terrestrial communication frequency band or a satellite communication frequency band this outside of the communication frequency band.

20. The apparatus of claim 11, further comprising:
employing a local timing control component to obtain one or more of the time reference, the radio frame start time, or the slot pattern.
